(19) United States
(12) Patent Application Publication
(10) Pub. No.: US 2023/0191165 A1
(43) Pub. Date: Jun. 22, 2023

(54) DEVICES FOR FACILITATING BREATHING AND METHODS OF USING AND CONSTRUCTING THE SAME

(71) Applicants: Nathan Glass, Fortville, IN (US); Thomas R. Ryder, Fishers, IN (US)

(72) Inventors: Nathan Glass, Fortville, IN (US); Thomas R. Ryder, Fishers, IN (US)

(21) Appl. No.: 17/921,758

(22) PCT Filed: Apr. 27, 2021
(86) PCT No.: PCT/US2021/029494

§ 371 Date: Oct. 27, 2022

Related U.S. Application Data
(60) Provisional application No. 63/016,218, filed on Apr. 27, 2020.

(51) Int. Cl. A62B 7/02; A62B 17/04

(52) U.S. Cl. CPC A62B 7/02; A62B 17/04

(57) ABSTRACT

Devices for facilitating breathing and methods of using and constructing the same. In at least one embodiment of a device for facilitating breathing of the present disclosure, the device comprises a generally cylindrical central portion configured to surround a head of a user, a top portion coupled to a relative upper end of the central portion, a bottom portion coupled to a relative lower end of the central portion, and an access mechanism coupled to or formed as part of the central portion, the access mechanism configured to open to provide access to the head or a face of the user when the user is wearing the device.

### PRIORITY

The present application is related to, and claims the priority benefit of, U.S. Provisional Patent Application Ser. No. 63/016,218, filed Apr. 27, 2020, the contents of which are incorporated herein by reference in their entirety.

### BACKGROUND

Viruses and other antigens causing labored breathing, such as corona virus 19 (COVID-19) plaguing the world at the time of filing the present application, result in the need and use of an extremely high number of devices to assist patient breathing, such as breathing masks, hoods, and intubations. Said devices can be expensive, uncomfortable, and may need to be used with several patients, resulting in a potential contamination concern.

As such, a breathing device, configured as a hood, that is effective, comfortable, and inexpensive would be well received in the marketplace.

### BRIEF SUMMARY

The present disclosure includes disclosure of devices, and methods of producing the same, that, when worn by a mammalian patient, can create a positive air pressure therein to increase oxygen flow into the patient's lungs as to compared to an amount of oxygen that can flow into the same patient's lungs without said device and/or without as much exertion by said patient. Said devices would be configured as hoods that are effective, comfortable, and inexpensive.

In at least one embodiment of a device for facilitating breathing of the present disclosure, the device comprises a generally cylindrical central portion configured to surround a head of a user, a top portion coupled to a relative upper end of the central portion, a bottom portion coupled to a relative lower end of the central portion, and an access mechanism coupled to or formed as part of the central portion, the access mechanism configured to open to provide access to the head or a face of the user when the user is wearing the device.

In at least one embodiment of a device for facilitating breathing of the present disclosure, the device comprises a material that is fully or at least partially transparent.

In at least one embodiment of a device for facilitating breathing of the present disclosure, the device comprises a translucent material.

In at least one embodiment of a device for facilitating breathing of the present disclosure, the access mechanism is configured as a zipper.

In at least one embodiment of a device for facilitating breathing of the present disclosure, the access mechanism is configured as a flap valve.

In at least one embodiment of a device for facilitating breathing of the present disclosure, the access mechanism is configured as a leaflet valve.

In at least one embodiment of a device for facilitating breathing of the present disclosure, the access mechanism is configured as a hook and loop fastener.

In at least one embodiment of a device for facilitating breathing of the present disclosure, the bottom portion comprises three layers or three portions of material.

In at least one embodiment of a device for facilitating breathing of the present disclosure, each layer of the three layers or three portions of material comprise a different type of material.

In at least one embodiment of a device for facilitating breathing of the present disclosure, the three layers or three portions of material comprises a lower section, a middle section, and an upper section.

In at least one embodiment of a device for facilitating breathing of the present disclosure, the lower section comprises a pliable, flexible material and is configured to fit around a neck of the user after the device has been placed over a head of the user such that the top portion is above the head of the user.

In at least one embodiment of a device for facilitating breathing of the present disclosure, the lower section is configured to stretch so that the device can be positioned over a head of the user and so that the lower section can fit around a neck of the user when the device is worn.

In at least one embodiment of a device for facilitating breathing of the present disclosure, the middle section has a plurality of apertures defined therethrough.

In at least one embodiment of a device for facilitating breathing of the present disclosure, the lower section can form an airtight seal with the middle section using tooling and pressure, and wherein the middle section can form an airtight seal with the upper section using the tooling and pressure.

In at least one embodiment of a device for facilitating breathing of the present disclosure, when the bottom portion, the central portion, and the top portion each comprise the same type of material, the bottom portion, the central portion, and the top portion can be mechanically or chemically bonded to one another.

In at least one embodiment of a device for facilitating breathing of the present disclosure, the top portion is connected to the central portion, wherein the central portion is further connected to the bottom portion, and within the bottom portion, the upper section is connected to the middle section, and the middle section is further connected to the lower section.

In at least one embodiment of a device for facilitating breathing of the present disclosure, the lower section has a neck opening defined therethrough, and wherein the neck opening is sized and shaped such that in a native, relaxed configuration, the lower section can comfortably fit around a neck of the user.

In at least one embodiment of a device for facilitating breathing of the present disclosure, the device further comprises one or more ports defined therethrough.

In at least one embodiment of a device for facilitating breathing of the present disclosure, each port of the one or more ports comprise a port body having a port aperture defined therethrough.

In at least one embodiment of a device for facilitating breathing of the present disclosure, a flange section of the port body can be positioned adjacent to a portion of material of the central portion and extend through an opening defined within the central portion.

In at least one embodiment of a device for facilitating breathing of the present disclosure, external tubing can be connected to a port of the one or more ports while the flange section can be bonded to a portion of material of the central portion to form an airtight or sufficiently airtight seal.

In at least one embodiment of a device for facilitating breathing of the present disclosure, the device further comprises two or more ports defined therethrough.

In at least one embodiment of a device for facilitating breathing of the present disclosure, a first port of the two or more ports is located at a part of central portion located away from an ear and relatively near the side of a mouth of the user when the user is wearing the device.

In at least one embodiment of a device for facilitating breathing of the present disclosure, when external tubing is connected to the first port of the two or more ports, air can be delivered through the external tubing through the first port whereby said air is not directed to blow into eyes or an ear of the user.

In at least one embodiment of a device for facilitating breathing of the present disclosure, a second port of the two or more ports is located relatively opposite to the first port or generally away from first port such that exhaled air can be evacuated through the second port.

In at least one embodiment of a device for facilitating breathing of the present disclosure, a first port is positioned relatively higher than the second port.

In at least one embodiment of a device for facilitating breathing of the present disclosure, the device further comprises one or more upper flaps formed from excess material of the top portion.

In at least one embodiment of a device for facilitating breathing of the present disclosure, the device further comprises one or more lower flaps formed from excess material of the bottom portion.

In at least one embodiment of a device for facilitating breathing of the present disclosure, the device further comprises one or more flap apertures defined within the one or more upper flaps and the one or more lower flaps.

In at least one embodiment of a device for facilitating breathing of the present disclosure, the one or more flap apertures are configured to receive portions of one or more straps or other items to help hold the device in place.

In at least one embodiment of a device for facilitating breathing of the present disclosure, said device does not use or require any sort of rigid ring configured to fit around a neck of the user.

In at least one embodiment of a device for facilitating breathing of the present disclosure, the device is configured to collapse and expand.

In at least one embodiment of a device for facilitating breathing of the present disclosure, the device comprises material suitable to withstand sterilization.

### BRIEF DESCRIPTION OF THE DRAWINGS

The disclosed embodiments and other features, advantages, and disclosures contained herein, and the matter of attaining them, will become apparent and the present disclosure will be better understood by reference to the following description of various exemplary embodiments of the present disclosure taken in conjunction with the accompanying drawings, wherein:

FIGS. 1 and 2 show perspective views of breathing devices, according to an exemplary embodiment of the present disclosure;

FIG. 3 shows an exploded perspective view of elements of a bottom portion of a breathing device, according to an exemplary embodiment of the present disclosure;

FIG. 4 shows a front perspective view of a person wearing a device, according to an exemplary embodiment of the present disclosure;

FIG. 5 shows a side perspective view of a person wearing the device shown in FIG. 4, according to an exemplary embodiment of the present disclosure;

FIG. 6 shows a relatively rear perspective view of a person wearing the device shown in FIG. 4, according to an exemplary embodiment of the present disclosure;

FIG. 7 shows a front perspective view of the device of FIG. 4, according to an exemplary embodiment of the present disclosure; and

FIG. 8 shows a front perspective view of a partially collapsed device having straps coupled thereto, according to an exemplary embodiment of the present disclosure.

As such, an overview of the features, functions and/or configurations of the components depicted in the various figures will now be presented. It should be appreciated that not all of the features of the components of the figures are necessarily described and some of these non-discussed features (as well as discussed features) are inherent from the figures themselves. Other non-discussed features may be inherent in component geometry and/or configuration. Furthermore, wherever feasible and convenient, like reference numerals are used in the figures and the description to refer to the same or like parts or steps. The figures are in a simplified form and not to precise scale.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

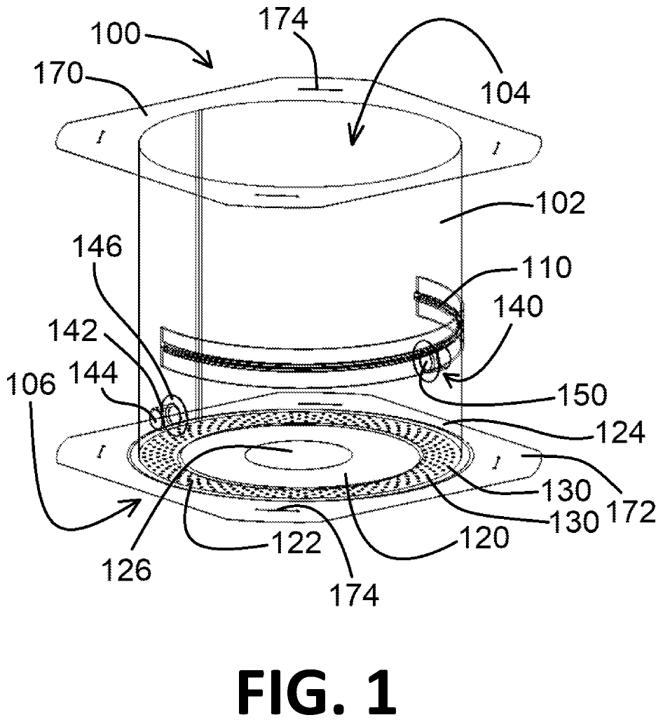

An exemplary device 100 of the present disclosure is shown in FIG. 1. As shown in FIG. 1, device 100 is configured as a hood configured to be worn by a mammalian patient, such as a human, canine, feline, or other mammalian patient. Device 100, in at least one embodiment, comprises a generally cylindrical central portion 102, a top portion 104, and a bottom portion 106. Central portion 102, in various embodiments, would comprise a material that is fully or at least partially transparent, or at a minimum translucent, so that a caregiver can see the face of the patient, for example, from the outside of device 100.

As shown in FIG. 1, top portion 104 is connected to central portion 102 at a relative upper end of central portion 102, and bottom portion 106 is connected to central portion 102 at a relative lower end of central portion 102. So to be able to access the head, face, mouth, eyes, and/or nose, etc., of the patient wearing device 100, some sort of access mechanism is required. In at least one embodiment, and as shown in FIG. 1, an access mechanism 110 is coupled to or formed as part of central portion 102. An exemplary access mechanism 110 of the present disclosure is configured as a zipper. Other access mechanisms 110 are contemplated herein, such as flap valves, leaflet valves, section(s) of central portion 102 configured to open and close using a hook and loop fastener (such as Velcro®, for example), etc.

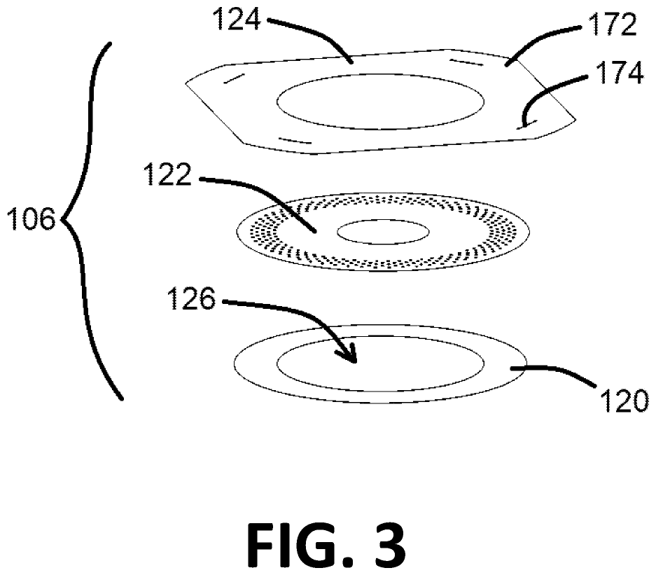

An exemplary bottom portion 106 of the present disclosure may comprise three layers or portions of material, such as a lower section 120, a middle section 122, and an upper section 124, such as shown in FIG. 3. Lower section 120, middle section 122, and upper section 124 of bottom portion 106 may each comprise a different type of material, including materials that cannot effectively be welded and/or chemically bonded to one another. For example, and as shown in FIG. 3, lower section 120 comprises a pliable, flexible material that can be comfortably positioned around a patient's neck after device 100 has been placed over the patient's head such that top portion 104 is above the patient's head and bottom portion 106 is located at or near the patient's neck. To facilitate the same, lower section 120 of bottom portion 106 would be stretched, so that a neck opening 126 defined within lower section 120 is enlarged, when positioned over the head.

An exemplary middle section 122 of a bottom portion 106 is shown in FIGS. 1 and 3, wherein said middle section 122 has a plurality of apertures 130 defined therethrough as identified in FIG. 1. Using proper tooling and pressure, a mechanical bond having an airtight seal (or at least a sufficiently airtight seal so that device 100 can serve its intended function) can be made so to connect lower section 120 to middle section 122, and also to connect upper section 124 to middle section 122, such as shown in FIG. 1. As such, a bottom portion 106 having, for example, and opaque or translucent lower section 120 can be effectively coupled to an upper section 124 comprising the same transparent material (for example) as central portion 102, by way of coupling said sections together using middle section 122 and proper tooling and pressure to create the necessary bond.

In instances where the type of material used is the same with bottom portion 106, central portion 102, and top portion 104, top portion 104 can be mechanically or chemically bonded to central portion 102 at a relative top of central portion 102, and bottom portion can be mechanically or chemically bonded to central portion 102 at a relative bottom of central portion. In such an embodiment, and when considered from a relative top down, top portion 104 is connected to central portion 102, which is connected to bottom portion 106, and within bottom portion 106, upper section 124 and lower section 120 are coupled to one another by way of a suitable middle section 122, to form said device 100.

Bottom portions 106 of devices 100 of the present disclosure are not rigid, in that the material(s) used for bottom portion 106 must be sufficiently pliable and stretchable so that bottom portion 106 can be stretched (so to enlarge neck opening 126) when being positioned about a patient's head until bottom portion 106 is located at or near the neck of the patient, and then relaxed (or “unstretched” or otherwise allowed to revert back to a native configuration) in a way that bottom portion 106 (at neck opening 126) is sufficiently snug around a patient's neck but not too snug as to exert undesired pressure about the neck and throat of the patient wearing said device 100. As such, neck opening 126 of lower section 120 of bottom portion 106 would be sized and shaped such that in a native, relaxed configuration, lower section 120 comfortably fits around a patient's neck.

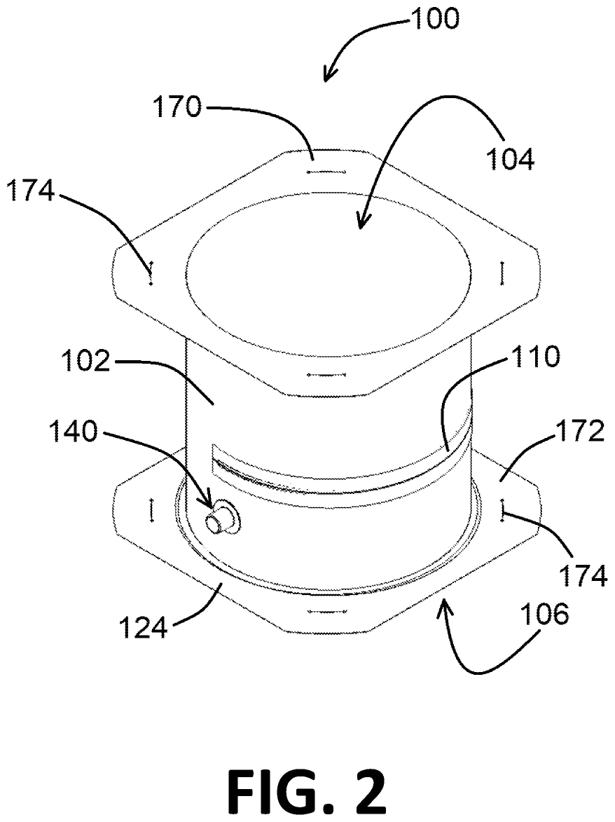

Exemplary devices 100 of the present disclosure also have one or more ports 140 defined therethrough, such as shown in FIGS. 1 and 2. As shown therein, ports 140 comprise a port body 142 having a port aperture 144 defined therethrough, whereby a flange section 146 of port body 142 can be positioned adjacent to a portion of material of central portion 102 and extending through an opening defined through central portion 102, such that part of port body 142 extends through an opening to a relative outside of device 100, allowing external tubing 160 to be connected to said port 140, and also allowing flange section 146 to be bonded to a portion of material of central portion 102 to form an airtight or sufficiently airtight seal.

Said ports 140 allow for external tubing 160, such as medical air supply and return lines, to be connected thereto. For example, and in at least one embodiment, a first port 140 may be located at a part of central portion 102 that would exist away from the patient's ear, and relatively near the side of the patient's mouth, whereby said port 140 can be used to deliver air to the patient in a comfortable way to the patient (such as, for example, not blowing into the patient's ear or eyes, which would be uncomfortable). A second port 140 can then be located elsewhere, such as relatively opposite to first port 140 or generally away from first port 140 such that air from first port 140 can be delivered to the patient's nose and/or mouth, and exhaled air (containing carbon dioxide from the lungs) can be evacuated from second port 140, and whereby the air flow in and the air flow out do not hinder one another. In at least one embodiment, first port 140 would be positioned relatively higher than second port 140 (such as near the top of the patient's head) so that air can blow across a patient's face as desired, but not directly into the eye or ear of the patient.

For example, and when in use, a device 100 of the present disclosure can be worn by a patient as referenced herein, and air (with a desired concentration of oxygen) can be delivered from a source of said air, through tubing 160 and a first port 140 into an interior of device 100, whereby said air can be inhaled by the patient. Exhaled air, along with some introduced air as may be the case, can exit device 100 through a second port 140 and through any other elements coupled thereto.

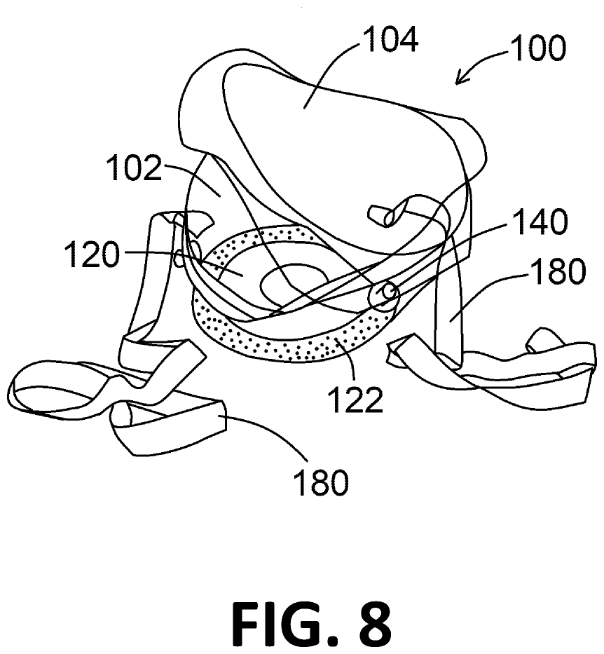

As shown in FIGS. 1 and 2, for example, excess material of top portion 104 and/or upper section 124 of bottom portion 106 may be present and/or allowed to remain after bonding to central portion 102, so to form or create one or more upper flaps 170 and/or one or more lower flaps 172. Flap apertures 174 can be defined within upper flaps 170 and/or lower flaps 172, such as shown in FIG. 1, so to permit portions of strap(s) 180, such as shown in FIG. 8, or other items to be positioned therethrough and/or connected thereto to help hold device 100 in place and to prevent undesired tipping of said device. Various accessories used in connection with devices 100 of the present disclosure can be attached directly to the film.

It is expressly noted that devices 100 of the present disclosure do not use or require any sort of rigid ring, namely a rigid circular element for positioning around a neck of a patient and potentially having port connections defined therein. Said devices introduce additional cost to breathing devices, and the additional weight and presence of the rigid ring can cause discomfort to a patient wearing such a device who is also trying to relax while breathing.

Exemplary devices 100 of the present disclosure can comprise a top portion 104 which is essentially a flat piece of transparent pliable material, that is coupled to an upper perimeter of a central portion 102, which itself is cylindrical or generally cylindrical when fully opened (noting that the flexible nature of the material used allows for various “shapes” of central portion 102). Bottom portions 106 can comprise three pieces of material, namely a lower section 120, a middle section 122, and an upper section 124 as referenced herein, such that the overall structure of an exemplary device 100 of the present disclosure comprises five (5) pieces of material connected together as referenced herein.

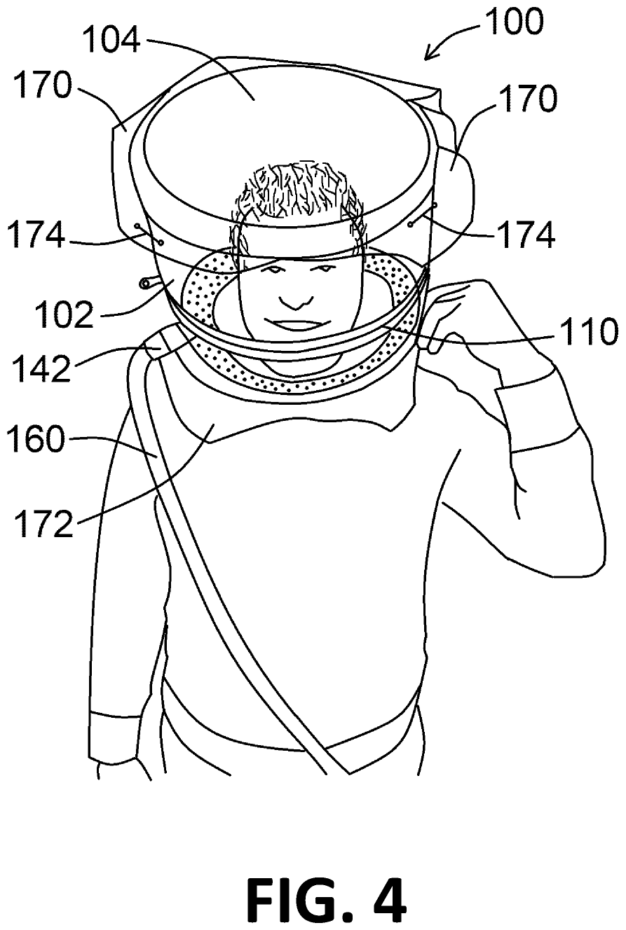

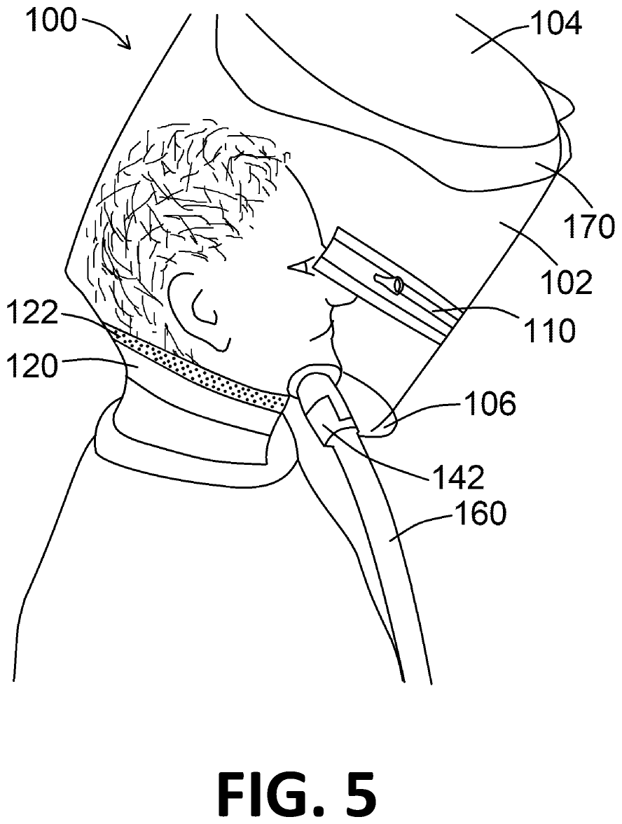

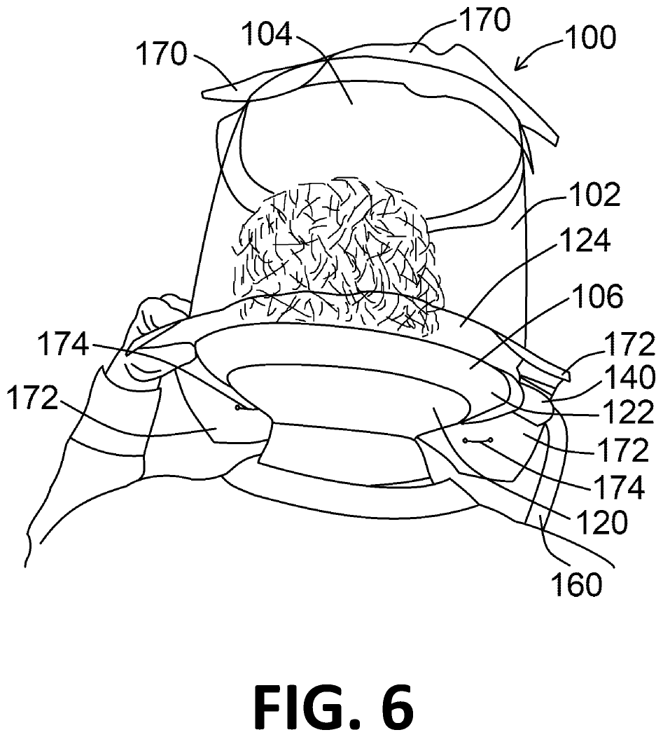

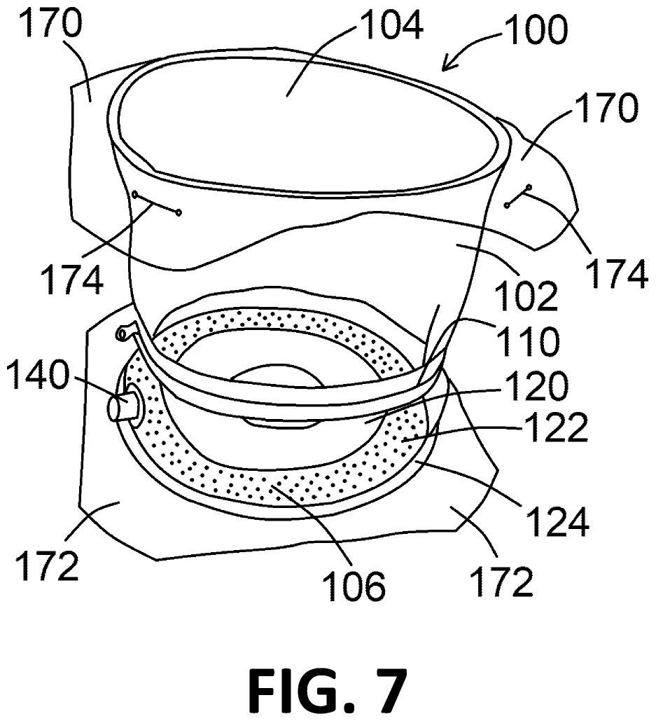

FIGS. 4-6 depict a person comfortably wearing an exemplary device 100 of the present disclosure. As shown therein, tubing 160 can be attached to port(s) of device 100 and used as referenced herein. FIGS. 7 and 8 show an exemplary device 100 of the present disclosure, identifying its collapsible nature. In at least one embodiment, device 100 can collapse and fit within a container having dimensions under 1.5″ high and under 13″ wide and under 13″ deep, such as, for example, a container that is at or approximately 1″ high, 12″ wide, and 12″ deep.

Said devices of the present disclosure can be intended for single use (disposed after one use), or can be intended for multiple uses. If the latter, devices 100 would comprise materials suitable for sterilization, such as high temperature sterilization, chemical sterilization, ultraviolet light sterilization, and the like.

While various embodiments of devices for facilitating breathing and methods for using and constructing the same have been described in considerable detail herein, the embodiments are merely offered as non-limiting examples of the disclosure described herein. It will therefore be understood that various changes and modifications may be made, and equivalents may be substituted for elements thereof, without departing from the scope of the present disclosure. The present disclosure is not intended to be exhaustive or limiting with respect to the content thereof.

Further, in describing representative embodiments, the present disclosure may have presented a method and/or a process as a particular sequence of steps. However, to the extent that the method or process does not rely on the particular order of steps set forth therein, the method or process should not be limited to the particular sequence of steps described, as other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. A device for facilitating breathing, comprising:
a generally cylindrical central portion configured to surround a head of a user;
a top portion coupled to a relative upper end of the central portion;
a bottom portion coupled to a relative lower end of the central portion; and
an access mechanism coupled to or formed as part of the central portion, the access mechanism configured to open to provide access to the head or a face of the user when the user is wearing the device;
wherein the device comprises a material that is fully or at least partially transparent.

2. (canceled)

3. (canceled)

4. (canceled)

5. (canceled)

6. The device of claim 1, wherein the access mechanism is selected from the group consisting of a zipper, a flap valve, and a leaflet valve.

7. The device of claim 1, wherein the access mechanism is configured as a hook and loop fastener.

8. (canceled)

9. The device of claim 1, wherein the bottom portion comprises three layers or three portions of material, and wherein each layer of the three layers or three portions of material comprise a different type of material.

10. The device of claim 1, wherein the three layers or three portions of material comprises a lower section, a middle section, and an upper section, and wherein the lower section comprises a pliable, flexible material and is configured to fit around a neck of the user after the device has been placed over a head of the user such that the top portion is above the head of the user.

11. (canceled)

12. The device of claim 10, wherein the lower section is configured to stretch so that the device can be positioned over a head of the user and so that the lower section can fit around a neck of the user when the device is worn, and wherein the middle section has a plurality of apertures defined therethrough.

13. (canceled)

14. The device of claim 10, wherein the lower section can form an airtight seal with the middle section using tooling and pressure, and wherein the middle section can form an airtight seal with the upper section using the tooling and pressure.

15. The device of claim 1, wherein when the bottom portion, the central portion, and the top portion each comprise the same type of material, the bottom portion, the central portion, and the top portion can be mechanically or chemically bonded to one another.

16. The device of claim 10, wherein the top portion is connected to the central portion, wherein the central portion is further connected to the bottom portion, and within the bottom portion, the upper section is connected to the middle section, and the middle section is further connected to the lower section, and wherein the lower section has a neck opening defined therethrough, and wherein the neck opening is sized and shaped such that in a native, relaxed configuration, the lower section can comfortably fit around a neck of the user.

17. (canceled)

18. (canceled)

19. The device of claim 1, further comprising one or more ports defined therethrough, and wherein each port of the one or more ports comprise a port body having a port aperture defined therethrough.

20. The device of claim 19, wherein a flange section of the port body can be positioned adjacent to a portion of material of the central portion and extend through an opening defined within the central portion, and wherein external tubing can be connected to a port of the one or more ports while the flange section can be bonded to a portion of material of the central portion to form an airtight or sufficiently airtight seal.

21. (canceled)

22. The device of claim 1, further comprising two or more ports defined therethrough, wherein a first port of the two or more ports is located at a part of central portion located away from an ear and relatively near the side of a mouth of the user when the user is wearing the device.

23. (canceled)

24. (canceled)

25. The device of claim 22, wherein when external tubing is connected to the first port of the two or more ports, air can be delivered through the external tubing through the first port whereby said air is not directed to blow into eyes or an ear of the user, and wherein a second port of the two or more ports is located relatively opposite to the first port or generally away from first port such that exhaled air can be evacuated through the second port.

26. The device of claim 22, wherein a first port is positioned relatively higher than the second port.

27. (canceled)

28. The device of claim 1, further comprising one or more upper flaps formed from excess material of the top portion and one or more lower flaps formed from excess material of the bottom portion.

29. The device of claim 28, further comprising one or more flap apertures defined within the one or more upper flaps and the one or more lower flaps, and wherein the one or more flap apertures are configured to receive portions of one or more straps or other items to help hold the device in place.

30. (canceled)

31. The device of claim 1, wherein said device does not use or require any sort of rigid ring configured to fit around a neck of the user.

32. The device of claim 1, configured to collapse and expand.

33. The device of claim 1, comprising material suitable to withstand sterilization.

34. The device of claim 1, configured for use with a method, the method comprising the steps of:
positioning the device over a head of the user so that the bottom portion is positioned around a neck of the user;
connecting tubing to the device so to provide air to the user through the tubing and into the device.
